(19) United States
(12) Patent Application Publication
(10) Pub. No.: US 2026/0339815 A1
(43) Pub. Date: Oct. 29, 2026

(54) EXTRACTING ALERT RULES FROM LOG FILES USING LANGUAGE MODELS

(71) Applicant: Microsoft Technology Licensing, LLC, Redmond, WA (US)

(72) Inventors: Ryan A. BECKETT, Bellevue, WA (US); Behnaz ARZANI, Woodinville, WA (US); Siva Kesava Reddy KAKARLA, Redmond, WA (US); Yu YAN, Champaign, IL (US)

(73) Assignee: Microsoft Technology Licensing, LLC, Redmond, WA (US)

(21) Appl. No.: 19/193,764

(22) Filed: Apr. 29, 2025

(51) Int. Cl. G06F 11/34; G06F 11/30

(52) U.S. Cl. CPC G06F 11/3476; G06F 11/3072

(57) ABSTRACT

This document relates to using machine learning models to automate the process of generating alert rules for computing systems. The disclosed techniques can generate templates that match log entries from system logs. Then, the templates can be employed to generate alert rules that specify certain conditions when alerts should be triggered. In some implementations, the machine learning model is invoked responsive to a determination that a given log entry does not already match an existing template. Thus, the number of invocations of the machine learning model is proportional to the number of templates, rather than the number of log entries. Since there are often many more log entries than templates, this approach can yield significant computational savings compared to approaches that might process each log entry using the machine learning model.

### BACKGROUND

Cloud computing services employ many different types of computing resources. For instance, a data center can include many different types of hardware devices, such as servers, processing units, network cards, routers, switches, server racks, cooling devices, etc. In addition, cloud computing servers can execute software ranging from low-level software such as device firmware, hypervisors, and operating system kernels to higher-level software such as application code or higher-level operating system services that are called directly by application code.

System administrators can manually write scripts that search log entries to identify specific problems for resolution, e.g., by generating an alert when a log entry matches a known fault pattern. This can allow the system administrator to identify a faulty hardware or software resource and take remedial action. However, in a large-scale computing system such as a data center, hardware and software logs can be very diverse and produced at a rate of gigabytes or even terabytes of per hour. Given the diversity and high rate at which log entries are produced in such systems, it is not practical to manually generate scripts that comprehensively cover the range of plausible fault patterns that can occur.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for extracting alert rules from log data. One example includes a computer-implemented method that can include retrieving log entries from a log file, the log entries having been generated by one or more hardware or software resources in a computing system. The method can also include prompting a generative language model to generate templates that match the log entries. The method can also include receiving the generated templates from the generative language model. The method can also include prompting the generative language model to evaluate suitability of the generated templates for generating alert rules. The method can also include receiving, from the generative language model, indications that selected templates are suitable for generating the alert rules. The method can also include generating the alert rules based at least on the selected templates.

Another example entails a system that includes a processor and a storage medium storing instructions. When executed by the processor, the instructions can cause the system to retrieve log entries from a log file, the log entries having been generated by one or more hardware or software resources in a computing system. The instructions can also cause the system to prompt a generative language model to generate templates that match the log entries. The instructions can also cause the system to receive the generated templates from the generative language model. The instructions can also cause the system to prompt the generative language model to evaluate suitability of the generated templates for generating alert rules. The instructions can also cause the system to receive, from the generative language model, indications that selected templates are suitable for generating the alert rules. The instructions can also cause the system to generate the alert rules based at least on the selected templates.

Another example includes a computer-readable storage medium storing executable instructions which, when executed by a processor, cause the processor to perform acts. The acts can include retrieving log entries from a log file, the log entries having been generated by one or more hardware or software resources in a computing system. The acts can also include prompting a generative language model to generate templates that match the log entries. The acts can also include receiving the generated templates from the generative language model. The acts can also include prompting the generative language model to evaluate suitability of the generated templates for generating alert rules. The acts can also include receiving, from the generative language model, indications that selected templates are suitable for generating the alert rules. The acts can also include generating the alert rules based at least on the selected templates.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an overall workflow for generating and enforcing alert rules, consistent with some implementations of the present concepts.

FIG. 2 illustrates an example pattern mining prompt for generating a template that matches a log entry, consistent with some implementations of the present concepts.

FIG. 3A illustrates a format for generating prompts, consistent with some implementations of the present concepts.

FIGS. 3B and 3C illustrate an example prompt for evaluating suitability of a generated template for use in an alert rule, consistent with some implementations of the present concepts.

FIG. 4 illustrates an example alert rule obtained using a generated prompt, consistent with some implementations of the present concepts.

FIG. 5 illustrates an example template caching workflow, consistent with some implementations of the present concepts.

FIG. 6 illustrates an example constant matching workflow, consistent with some implementations of the present concepts.

FIG. 7 illustrates an example of a system in which the disclosed implementations can be performed, consistent with some implementations of the disclosed techniques.

FIG. 8 illustrates an example of a method, consistent with some implementations of the present concepts.

FIG. 9 illustrates an example of a graphical user interface that can be generated, consistent with some implementations of the present concepts.

FIG. 10 illustrates an example generative language model, consistent with some implementations of the present concepts.

### DETAILED DESCRIPTION

### Overview

As noted above, system logging is pervasive in cloud computing scenarios. Due to the massive amounts of data in hardware and software logs for a large data center and the diversity of patterns present in the logs, it is impractical to manually generate scripts that adequately cover the range of potential issues that could be indicated in the logs. Ideally, an automated approach could be employed to process system logs at scale to identify patterns for generating alert rules.

One candidate approach for automating the identification of alert rules from system logs involves using a generative language model. In recent years, generative language models have demonstrated the ability to generate text to summarize existing documents, help users draft new documents, and conduct natural language conversations with users at a very high level. In addition, generative language models have demonstrated the ability to process various types of technical data, such as log files, configuration files, source code, etc.

While generative language models have shown some ability to accurately process and demonstrate knowledge of system log files, it is not straightforward to use a generative language model directly to generate alert rules. Given the high rate at which system logs are generated in a data center, it is impractical to input log entries to a generative language model at the same rate at which log entries are generated in a data center. In addition, many log entries are redundant and/or merely informative, and it would be wasteful to call a generative language model to evaluate every redundant or merely informative log entry.

The disclosed implementations offer techniques for efficiently employing generative language models to generate alerting rules by processing system logs. In the disclosed techniques, a generative language model is first employed to parse log entries into templates that match the log entries. Next, information is extracted from those templates to learn alert rules. Because there are generally far fewer templates than log entries, learning the alert rules from the log templates rather than directly from the log entries requires far fewer invocations of the generative language model. Furthermore, because the templates represent a large number of individual log entries, the alert rules learned in this manner are still sufficiently comprehensive to adequately cover most or all important scenarios for generating alert rules.

### Machine Learning Overview

There are various types of machine learning frameworks that can be trained to perform a given task. Support vector machines, decision trees, and neural networks are just a few examples of machine learning frameworks that have been used in a wide variety of applications, such as image processing, computer vision, and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “log entry,” as used herein, refers to an item of data generated by a hardware or software resource that relates to the status of that hardware or software resource. The term “template” refers to an expression that can be evaluated to determine whether log entries match the template. For instance, templates can be implemented using regular expressions having literal characters, wildcards, etc. The term “alert rule” refers to a rule that can be applied to a log entry to determine whether an alert should be generated. An “alert” is a notification that indicates a specific condition of a hardware or software resource, e.g., a warning.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image. The term “suggested” refers to output predicted by a generative machine learning model, e.g., suggested tags, suggested values, and suggested images respectively refer to tags, values, and images predicted by a generative machine learning model.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Overall Workflow

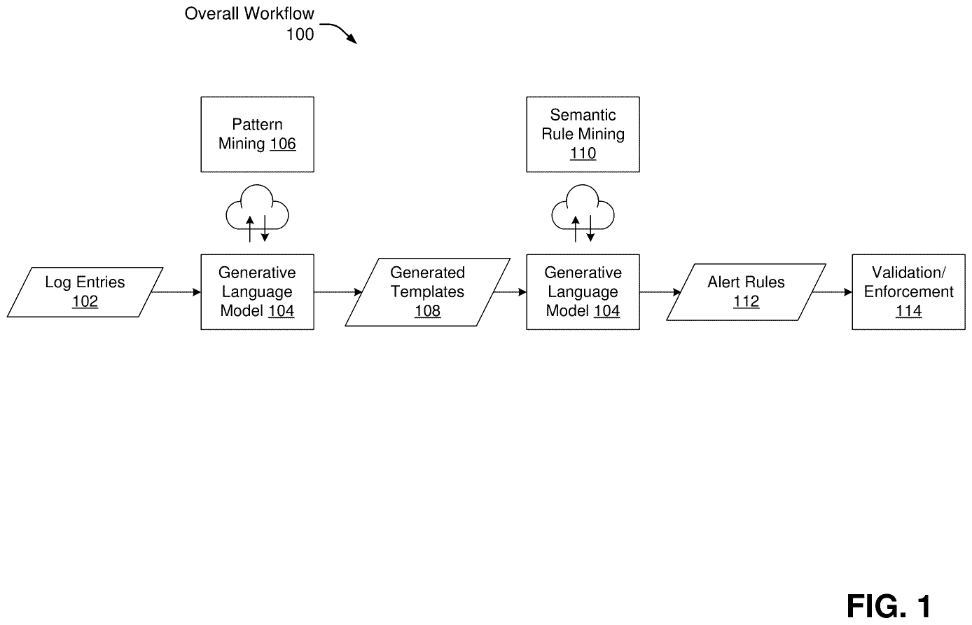

FIG. 1 illustrates an overall workflow 100 for generating alert rules from log entries. First, log entries 102 are input to a generative language model 104 for pattern mining 106. The pattern mining produces generated templates 108. Each template can be a regular expression that matches the log entry that is input to the generative language model. As discussed more below, in some cases, if a given log entry matches an existing template, then pattern mining is not necessarily performed for that log entry. Thus, the number of calls to the generative language model is proportional to the number of generated templates rather than the number of log entries.

Once pattern mining 106 is completed, the generated templates are processed by generative language model 104 for semantic rule mining 110. For instance, the semantic rule mining can involve prompting the generative language model to determine whether each template is suitable for generating one or more alert rules. For instance, as discussed more below, this can involve inputting alert rule descriptions to the generative language model with the templates.

The semantic rule mining produces alert rules 112. For instance, the generative language model 104 can be prompted to generate different components of each alert rule, such as aggregation types, variable groupings, etc. Then, the generated alert rules can be employed for validation/enforcement 114, where the generated alert rules are validated by testing and then used to generate alerts.

### Example Pattern Mining Prompt

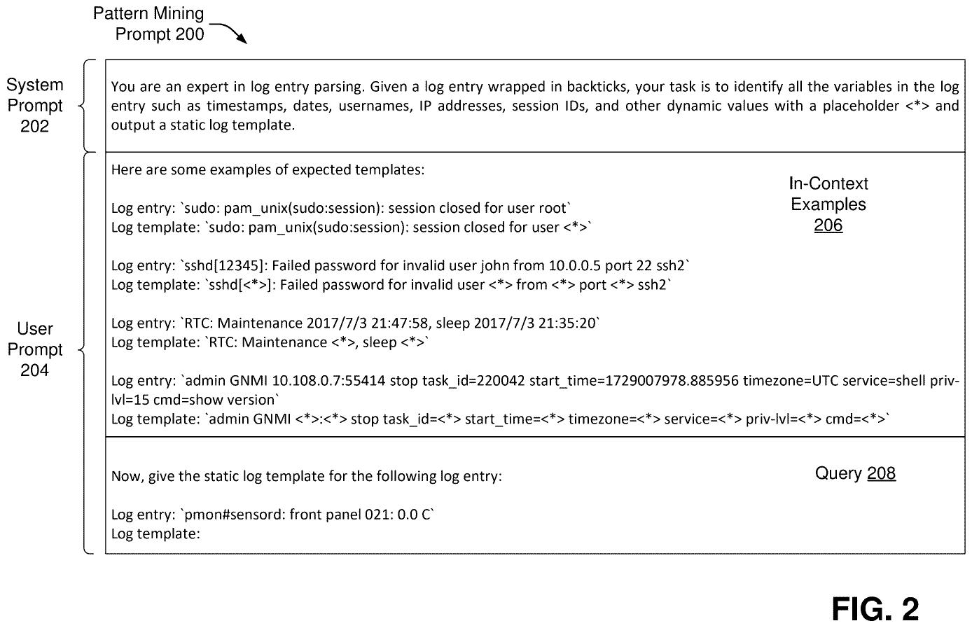

As noted above, pattern mining 106 can involve using the generative language model 104 to generate a template that matches a given log entry. FIG. 2 illustrates an example pattern mining prompt 200 that can be employed in this regard. The pattern mining prompt 200 has a system prompt 202 and a user prompt 204, which includes in-context examples 206 and a query 208. The system prompt and user prompt are described more below.

Here, the system prompt 202 instructs the generative language model 104 to act as an expert in log entry parsing. The system prompt also provides context describing how the log entry will be formatted. In addition, the system prompt instructs the generative language model to use ‘<*>’ as a placeholder for variables in the log entry.

The user prompt 204 provides in-context examples 206. Each of these examples includes a log entry and a corresponding template that can be generated from that log entry. Thus, the in-context examples can condition the generative language model 104 to generate a new template for a new log entry in a manner consistent with the in-context examples. The user prompt 204 also includes a query 208. Here, the query includes the log entry ‘pmon #sensord: front panel 021: 0.0 C’ for the generative language model to generate a matching template. Assume the generative language model generates the following template: ‘pmon #sensord: front panel <*>: <*>C’ which will be employed for the following examples. Note that ‘<*>’ is simplified version of a standard regular expression, ‘(. *)’, which can be employed for or subsequent processing. More generally, the generative language model can be prompted to generate simplified versions of other standard regular expressions and then the simplified versions output by the generative language model can be translated into standard regular expressions for use in generating alert rules.

### Example Semantic Rule Mining Prompts

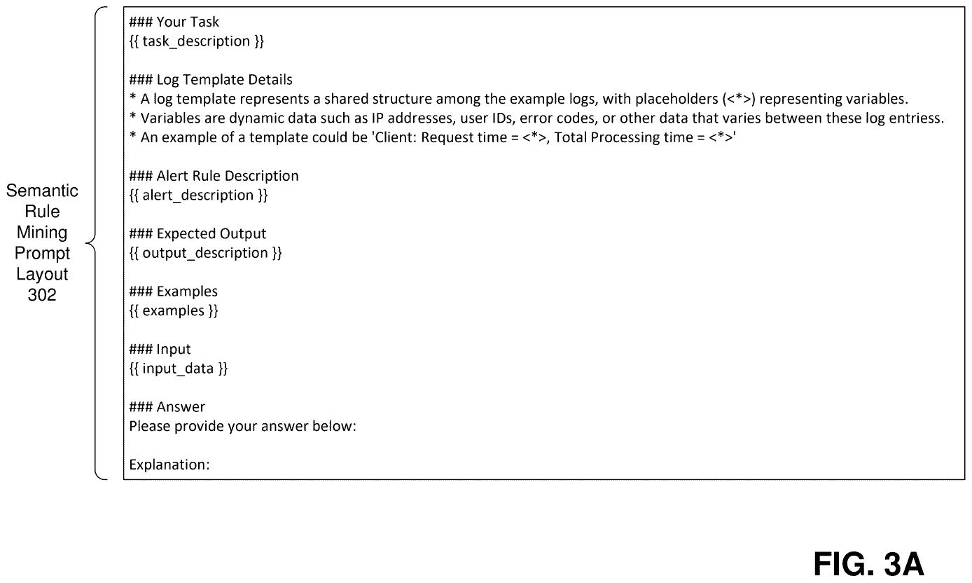

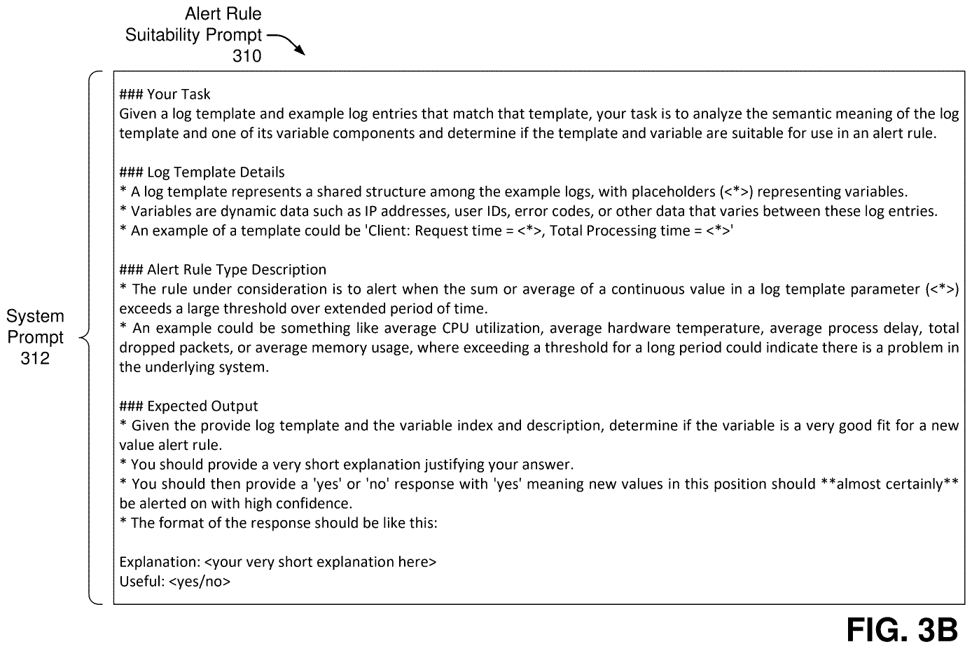

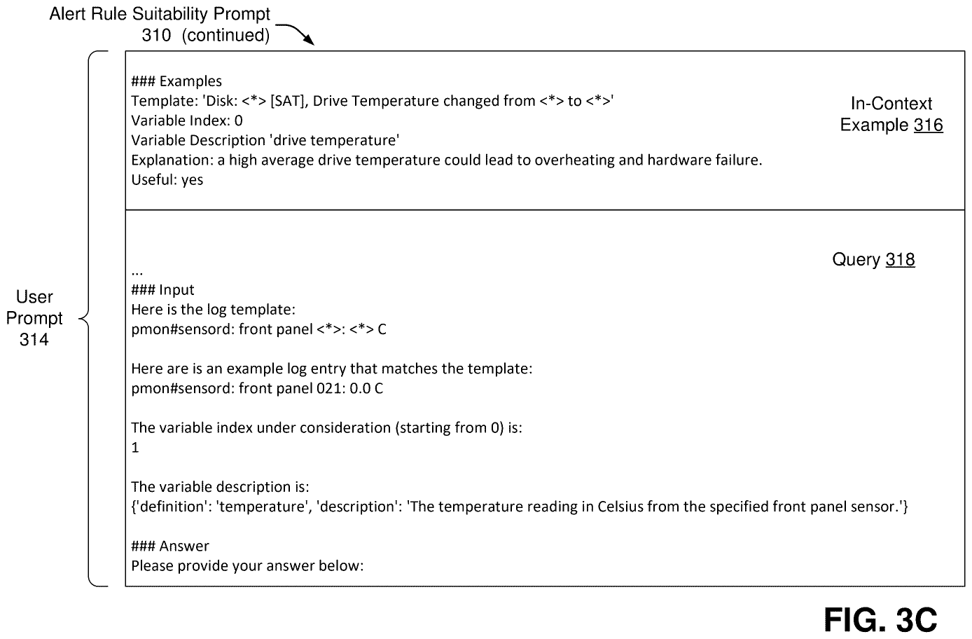

As noted above, semantic rule mining 110 can involve using the generative language model 104 to generate alert rules based on the generated templates 108. FIG. 3A illustrates an example semantic rule mining prompt layout 302. Generally, the semantic rule mining prompt layout can be employed to generate various prompts that are employed during semantic rule mining, as discussed in more detail below.

FIGS. 3B and 3C illustrate an example alert rule suitability prompt 310 that can be created according to the semantic rule mining prompt layout 302. Here, the alert rule suitability prompt 310 includes a system prompt 312 and a user prompt 314, which includes in-context example 316 and a query 318. The system prompt and the user prompt are discussed in more detail below.

Here, the system prompt 312 in FIG. 3B instructs the generative language model 104 to analyze the semantic meaning of a log template and a variable in the log template. The system prompt also instructs the generative language model to determine whether the variable and template are suitable for use in an alert rule. The system prompt provides details on the log template as well as a description of the alert rule type that is being evaluated. Here, the system prompt instructs the generative language model to evaluate whether a log template is suitable for a rule that generates an alert when the sum or average of a continuous value exceeds a threshold for an extended period of time. The system prompt also provides the expected output and format for the generative language model to employ.

The user prompt 314 in FIG. 3C includes an in-context example 316 that provides an example template, an example variable index and description, and an example output including an explanation and an indication of whether the template and variable are useful for the alerting rule under consideration. Note that additional in-context examples can be provided and only one is shown due to space constraints in the figure. User prompt 314 also includes a query 318, which includes the template itself, the variable index of the variable being considered, and a description of that variable.

For the following examples, assume that the generative language model 104 outputs the following response to alert rule suitability prompt 310:
Explanation: The front panel temperature is a continuous numeric metric, and deviations from expected ranges (e.g., exceeding the max threshold or falling below the min threshold) could indicate hardware issues such as power supply instability or cooling failure. Monitoring this value for sustained abnormal behavior is useful for determining the system's health.

Useful: Yes

When the generative language model indicates that a given template and variable is likely useful for a given alert rule type, then additional prompts can be provided to the generative language model to generate rule components, as described more below.

### Example Alert Rule

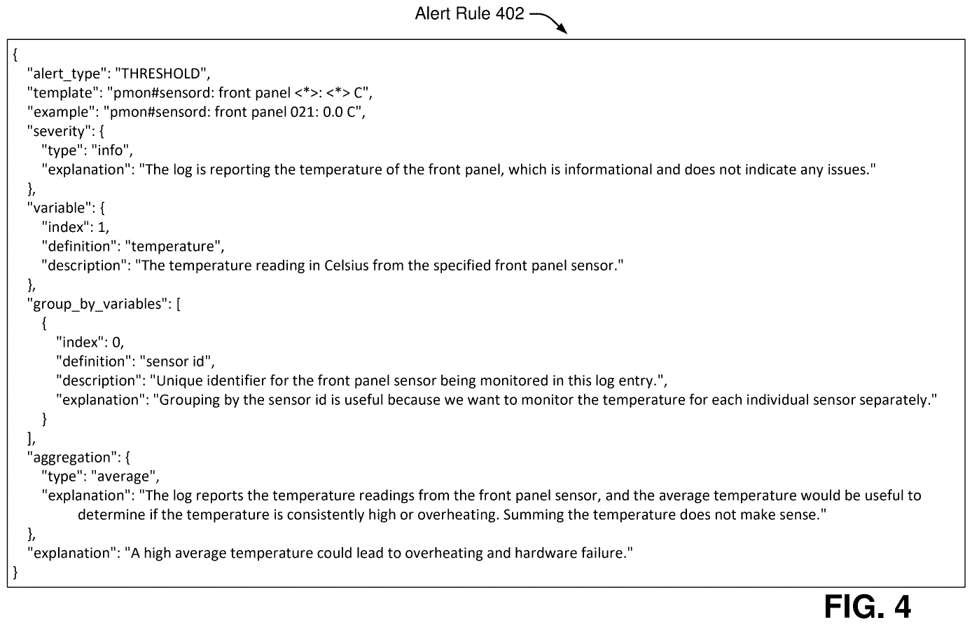

Once the various components of an alert rule have been generated, they can be assembled into an alert rule. FIG. 4 illustrates an example alert rule 402. Here, the alert rule is based on the temperature of the front panel exceeding a specified temperature. Note that the alert rule has various components. The alert rule type is a “THRESHOLD” alert, meaning that the value of a variable in a given template is compared to a threshold to determine whether an alert is actually generated. The alert type also has a component that specifies how variables are grouped to evaluate the alert rule. Here, the readings are grouped by sensor identifiers, e.g., the alert rule is applied to temperature readings associated with a particular sensor identifier. The aggregation type component is “average,” meaning that the values of the temperature variable are averaged over a window of time to determine whether the threshold is exceeded.

### Example Template Caching Workflow

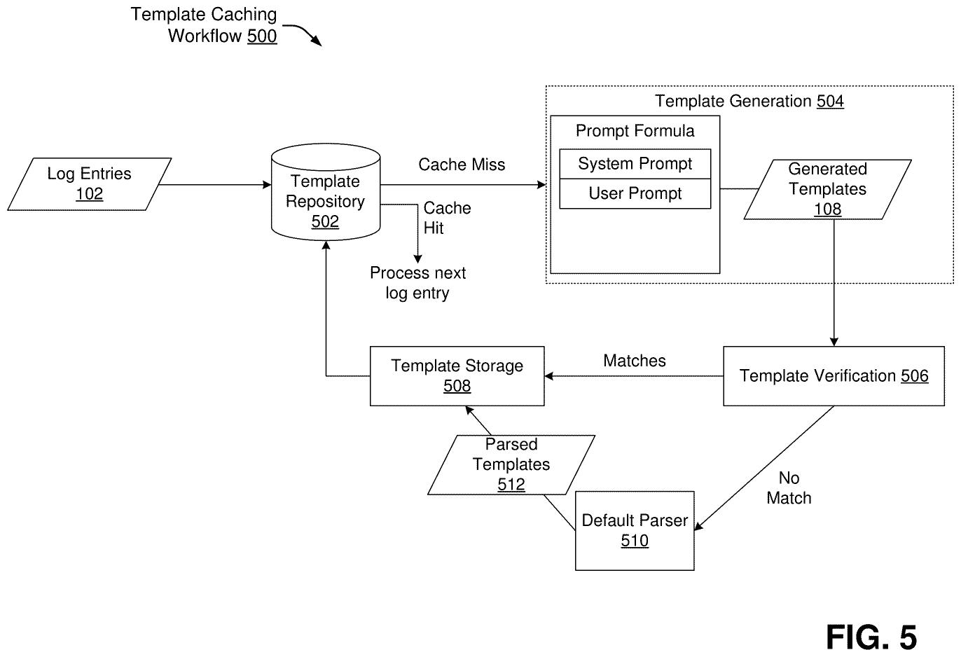

As noted above, in some implementations the generative language model 104 is invoked to determine a template for a given log entry responsive to a determination that there is not already an existing template that matches that log entry. FIG. 5 illustrates a template caching workflow 500 that provides additional details on how this can be performed.

First, log entries 102 are evaluated against a template repository 502 of previously-generated templates. If the log entry matches a template that is already present in the template repository, then the generative language model 104 is not invoked and the next log entry is retrieved for further processing. On the other hand, if there is no existing template in the template repository 502 that matches the current log entry, then template generation 504 is performed as described above, resulting in generated templates 108.

After template generation 504, the generated templates 108 are input to template verification 506 to ensure the templates output by the generative language model 104 match the current log entry. If the verifying succeeds, then template storage 508 is performed and the generated template is stored as a newly-generated template in the template repository 502. By verifying the templates prior to storing them in the template repository, it is possible to filter out erroneous templates output by the generative machine learning model.

If the generated template does not match the log entry, then default parser 510 can generate parsed templates 512. The default parser can be a rules-based parser that uses one or more rules to parse log entries into parsing-based templates. For instance, the rules-based parser can employ heuristic rules such as replacing numbers or other patterns (e.g., IP addresses) with ‘<*>’ so that the templates will match arbitrary numbers or IP addresses. Template storage 508 can also be employed to store the parsing-based templates in the template repository instead of erroneous templates produced by the generative machine learning model. Note that the parsing-based templates can also be employed for generating alert rules as described elsewhere herein with respect to the templates generated by the generative language model.

### Example Constant Matching Workflow

One way to determine whether a given log entry matches an existing template in the template repository 502 is to evaluate the log entry directly against that template. However, in some cases there may be many templates in the template repository, and it can be somewhat computationally intensive to evaluate every log entry against every existing template.

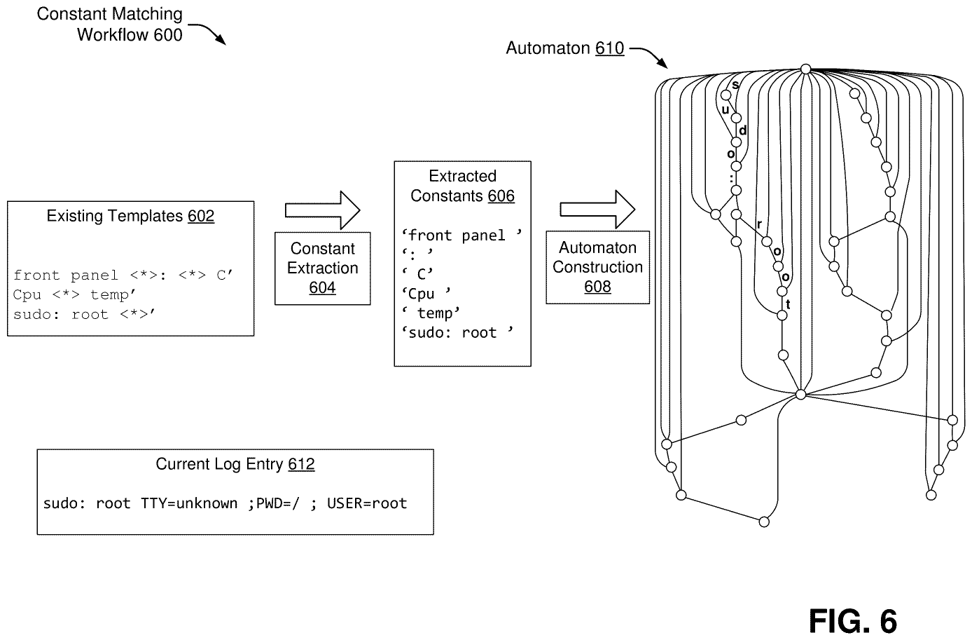

FIG. 6 shows a constant matching workflow 600 that can be employed to efficiently perform template filtering. First, existing templates 602 from the template repository 502 are processed using constant extraction 604. This can involve extracting constant values from each of the existing templates. The resulting extracted constants 606 are used during automaton construction 608 to generate an automaton 610.

For instance, in some implementations, the automaton 610 is used to implement the Aho-Corasick algorithm. Here, the automaton represents a dictionary of constants that are present in the existing templates 602. Then, a current log entry 612 can be processed using the automaton to determine whether the current log entry matches all of the constants in each of the existing templates. Then, only those existing templates for which all constants have corresponding matching values in the current log entry are compared to the current log entry when performing the template caching workflow 500. Said another way, any template that includes at least one constant that does not have a match in the current log entry is filtered out before the current log entry is evaluated for a match against the remaining templates. Generally, string matching using the automaton 610 is much less computationally intensive than determining whether a given log entry matches a given template. Thus, significant computational savings can be achieved by filtering out any existing templates that lack shared constants with the current log entry before determining whether the current log entry matches the remaining existing templates that share constants with the current log entry.

### Example System

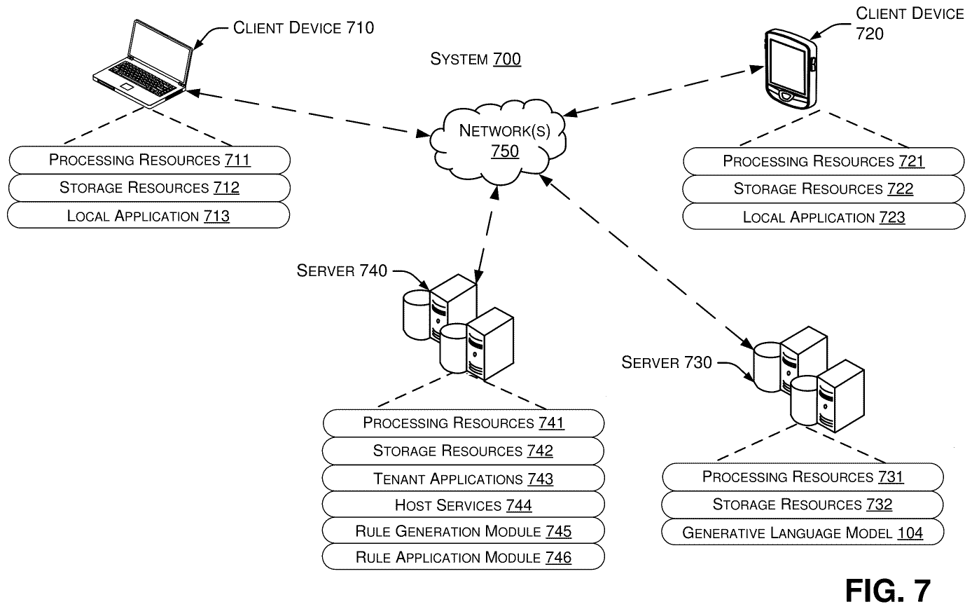

The present implementations can be performed in various scenarios on various devices. FIG. 7 shows an example system 700 in which the present implementations can be employed, as discussed more below.

As shown in FIG. 7, system 700 includes a client device 710, a client device 720, one or more server(s) 730, and one or more server(s) 740, connected by one or more network(s) 750. Note that the client device can be embodied both as a mobile device such as smart phones or tablets, as well as stationary devices such as desktops, server devices, etc. Likewise, the servers can be implemented using various types of computing devices. In some cases, any of the devices shown in FIG. 7, but particularly the servers, can be implemented in data centers, server farms, etc.

Client device 710 can have processing resources 711 and storage resources 712, client device 720 can have processing resources 721 and storage resources 722, server(s) 730 can have processing resources 731 and storage resources 732, and server(s) 740 can have processing resources 741 and storage resources 742. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 710 can include a local application 713 and client device 720 can include a local application 723. Server(s) 730 can host generative language model 104. Server(s) 740 can host one or more tenant applications 743, one or more host services 744, a rule generation module 745, and a rule application module 746.

The various devices in system 700 can generally interact as follows. Local application 713 on client device 710 and/or local application 723 on client device 720 can access tenant applications 743. For instance, the tenant applications can be web services, productivity applications, video games, financial applications, or other applications that utilize resources on server(s) 740 to perform various tasks for users of the client devices.

Host services 744 can include hypervisors or operating systems that implement functionality for the tenant applications 743. For instance, the host services can include higher-level operating system services that generate user interfaces, perform user authentication, implement file systems, etc. The host services can also include lower-level operating system services that manage memory, device drivers, etc. Host services can include a hypervisor that provides virtualized hardware to the operating system. In addition, the host services can also include other services that can be utilized by the tenant applications 743. For instance, the tenant applications can utilize database services, machine learning services, statistical services, physics engine services, audio or video rendering services, etc. that are provided by server(s) 740.

Rule generation module 745 can implement overall workflow 100 to generate one or more alert rules by interacting with generative language model 104 on server(s) 730. The alert rules can generally specify when an alert is generated by evaluating system logs generated by any hardware or software resource executing on server(s) 740. The rule application module 746 can monitor newly-generated system log entries to determine whether any of the log entries match one or more of the alert rules, and can also generate an alert when a match is identified.

### Example Method

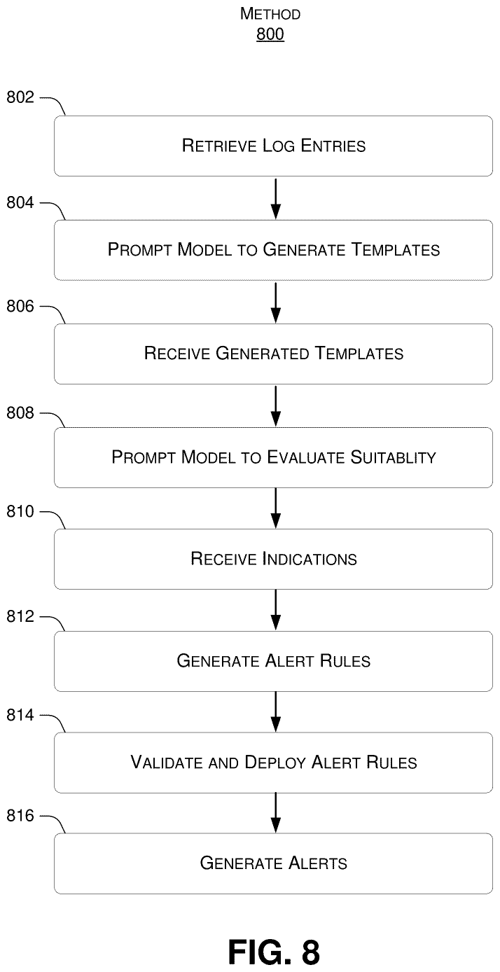

FIG. 8 illustrates an example computer-implemented method 800, consistent with some implementations of the present concepts. Method 800 can be implemented on many different types of devices, e.g., by one or more cloud servers, by a client device such as a laptop, tablet, or smartphone, or by combinations of one or more servers, client devices, etc.

Method 800 begins at block 802, where log entries are retrieved. For instance, the log entries can be generated by one or more hardware resources such as processing units, storage devices, network devices, server racks or blades, cooling devices, etc. The log entries can also be generated by one or more software resources such as operating systems, hypervisors, tenant applications, device firmware, database services, machine learning services, statistical services, etc.

Method 800 continues at block 804, where a generative language model is prompted to generate templates for the log entries. For instance, a pattern mining prompt can be input to the generative language model with a log entry and one or more examples of other log entries and matching templates. In some cases, block 804 is performed responsive to a determination that no existing template in a template repository matches the log entry that is currently being processed.

Method 800 continues at block 806, where the generated templates are received from the generative language model. For instance, the generative language model can generate regular expressions that match the log entries. The regular expressions can include constants as well as wildcards.

Method 800 continues at block 808, where the generative language model is prompted to evaluate suitability of the generated templates for use in alert rules. For instance, a semantic rule mining prompt can be input to the generative language model with a template, a description of variables in the template, a description of an alert rule, a description of expected output, and one or more examples. In some implementations, one prompt is generated for each rule type of a predefined set of alert rule types.

Method 800 continues at block 810, where indications are received from the generative language model that selected templates are suitable for generating the alert rules. For instance, the indication can be a natural language output from the generative language model (e.g., a yes) with an explanation of why the selected templates are suitable for alert rule generation. Block 810 can also include receiving other indications that other (e.g., non-selected) templates are not suitable for alert rule generation.

Method 800 continues at block 812, where the alert rules are generated. For instance, alert rule generation can include providing additional semantic rule mining prompts to the generative language model. The generative language model can output individual components of each alert rule in response. For instance, the components can include variable groupings, aggregation types, etc. In some cases the alert rules can be manually modified to include specific values for individual variables, e.g., a threshold temperature for one variable, a threshold ratio of two variables, etc. In other cases, these values are generated by the generative language model during block 812.

Method 800 continues at block 814, where the alert rules are validated and deployed. For instance, validation can include testing of the alert rules on a subset of hardware/software resources to ensure that extraneous alerts are not generated and/or that alerts are generated when appropriate. The validated rules can be deployed at scale by evaluating subsequent log entries as they are generated.

Method 800 continues at block 816, where alerts are generated using the alert rules. For instance, new log entries can be processed and alerts generated when the new log entries match at least one alert rule. In some implementations, block 816 also involves applying one or more mitigation actions to a hardware resource or software resource based on a generated alert, such as automatically restarting a software service, automatically updating firmware for a hardware device, etc. In addition, block 816 can include outputting a notification of a generated alert, e.g., by sending an email or text message to an account or device associated with a system administrator.

### Example User Interface

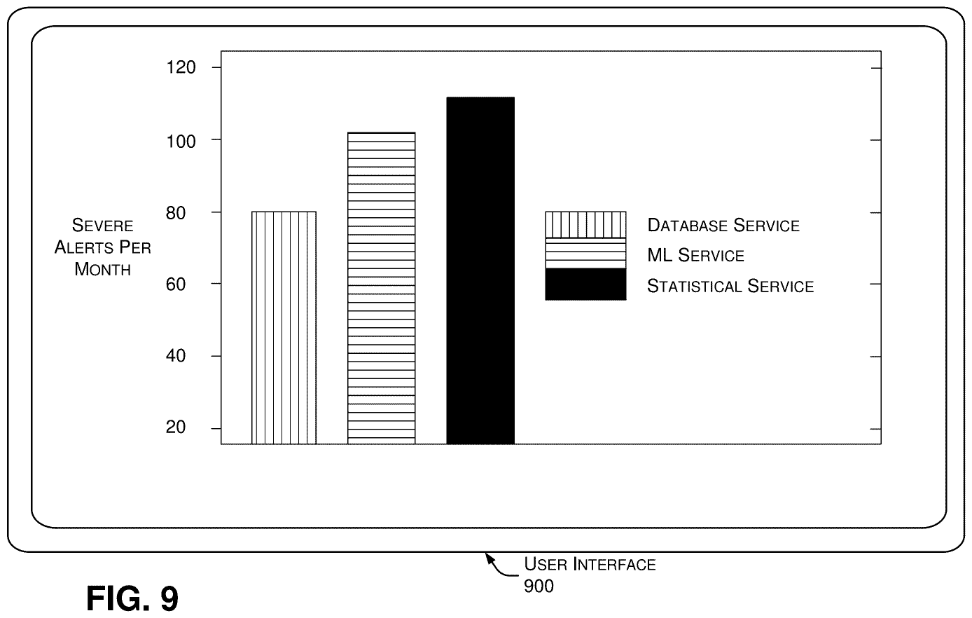

FIG. 9 illustrates an example graphical user interface 900 that can be employed once alert rules are deployed. Here, there are three software resources generating alerts-a database service, a machine learning (ML) service, and a statistical service. The graphical user interface indicates how many severe alerts are generated by each software resource on average per month. Since the statistical service generates the most severe alerts, this could help a system administrator or other skilled individual to evaluate the statistical service first.

Note that graphical user interface 900 is one example of many different graphical user interfaces that can be used to notify a user about alerts generated according to the disclosed implementations. For instance, in some implementations an alert can result in an immediate pop-up graphical user interface on a desktop or laptop of a system administrator or other individual that is responsible for mitigating failures in a given system.

### Additional Implementations

The examples introduced above provide an overview of the disclosed concepts. The following section describes additional scenarios that can be provided.

In many cases, hardware and/or software resources can change over time due to updates, replacement, new additions, etc. Thus, in some implementations, the disclosed techniques for generating alert rules can be implemented responsive to a change in a given system. For instance, assume that an operating system update is performed. In some implementations, log entries generated by the updated operating system can be processed using the disclosed techniques to generate one or more new alert rules, without necessarily using log entries generated by unchanged resources.

However, in some cases this approach may be insufficient. For instance, an update to an operating system could cause not only the operating system to change its logging behavior, but also other resources in the system. For instance, consider an example where an operating system update affects a router in a data center, and the router starts generating many new log entries as a result of the operating system update. In some implementations, statistical techniques can be employed to detect changes in logging behavior by a given resource. Then, whenever the logging behavior of that resource changes more than a threshold amount over a period of time, recent log entries by that resource can be processed to generate new alert rules.

As another point, in some cases, failures in a given system are not necessarily identified within a single log entry. For instance, consider a scenario where a tenant application experiences unacceptable latency only when (1) memory utilization is above 80% and (2) CPU utilization is above 50%. Any single log entry might only indicate memory utilization or CPU utilization in isolation. Thus, in some implementations, the generative language model can be prompted with sets of multiple log entries that occur together when a given failure mode is present. For instance, whenever the tenant application latency exceeds a threshold (e.g., 500 milliseconds), then the log entries generated during that condition can be input to the generative language model, which can infer the correlation between memory utilization and CPU utilization. Thus, an alert rule can be generated that evaluates log entries indicating memory utilization with contemporaneous log entries indicating CPU utilization, and alerts can be generated when both thresholds are exceeded.

As a further point, in some cases, templates can be relatively more general or relatively more specific. For instance, consider a scenario where the generative language model generates a first template with one constant and a wildcard character, and a second template that is identical to the first template with the exception of an additional constant. Thus, the first template subsumes the second template-any log entry that matches the second template will match the first template, but there can be log entries that match the first template but not the second. In some implementations, the more general template is always selected and used for alert rule generation. In other implementations, the more specific template is always selected and used for alert rule generation. In other cases, the generative language model can be prompted to choose between a more general and a more specific template, and the template selected by the generative language model can be employed for alert rule generation. For instance, the generative language model might select more specific templates in scenarios where the more general template matches log entries with different status codes and the more specific templates only match a single status code. The generative language model might select the more general template when a specific template matches the same status code as the more general template and only includes an additional punctuation mark or other single character.

With respect to alert rule types, the previous examples focused on a threshold rule alert type where the average value of particular variable exceeded a specified threshold for a designated period of time. Another type of alert rule is a log count alert rule type, which is triggered when a specific type of log entry is created more than a threshold number of times or at above a threshold rate. Another type of alert rule is a ratio alert rule type, which can be triggered when the ratio of one variable (e.g., user logins) to another variable (e.g., user logouts) falls outside of a specified ratio or range, e.g., 0.95 to 1.05. Another type of alert rule is a new value alert rule type, which is triggered the first time a log entry has a value for a given variable that has not been previously generated for that variable. Another type of alert rule is a unique count alert rule type, which can be generated when abnormal values are encountered for a variable that tracks unique occurrences, such as the number of users who encounter a specific HTTP error code, number of passwords received from a single IP address, etc. Another type of alert rule is a response time alert rule, which can be triggered when the execution time of a process or task exceeds a threshold value and/or a service times out. Another type of alert rule is an outlier alert rule type, which can be triggered when a variable exhibits statistical outlier behavior relative to past values, e.g., a device is generating far more or far fewer log entries than other similar devices, a device is missing heartbeat messages, etc. Another type of alert rule is an oscillation alert rule type which can be triggered when a variable has an oscillating value, e.g., the log entries indicate that a particular session or device keeps restarting.

As a final point, while the previous discussion notes that data centers in particular generate massive amounts of log entries, the disclosed techniques are not limited to generating alerts for data centers. Modern consumer devices, such as smartphones and laptops, are very complex devices with numerous hardware and software components. In addition, consumer devices also experience frequent software updates. Thus, the disclosed techniques can be employed in a wide range of computing systems, including data centers, individual consumer devices, vehicles, appliances, etc.

### Technical Effect

As noted above, the vast amount of system logging data generated in a system such as a large data center makes it impractical to manually generate a comprehensive set of alert rules. In theory, a generative language model could assist with generating alert rules by analyzing log entries directly. However, this is also not scalable, as the number of invocations of the generative language model would be proportional to the number of log entries. It is not practical to invoke a generative language model on log entries that are being generated at rates of gigabytes or terabytes per hour.

Using the disclosed techniques, the generative language model can be invoked for log entries that do not match an existing template. Thus, the number of invocations of the generative language model is proportional to the number of templates, rather than the number of log entries. In many cases, hundreds or thousands of log entries will match the same template. Thus, this approach dramatically reduces the number of calls to the generative language model, resulting in a corresponding savings of processor, memory, storage, and/or network resources that would otherwise be utilized to call the generative language model for every log entry.

As another point, the constant matching workflow described above with respect to FIG. 6 can also reduce usage of computing resources. By selecting a subset of existing templates with constants that match the log entries being currently evaluated, those log entries can be compared to only the templates in the subset while filtering out non-matching templates. Since constant matching is generally much more computationally efficient than determining whether a given log entry matches an entire template, this approach can save significant computational resources by filtering out existing templates that do not share constants with the log entries being evaluated.

### Example Decoder-Based Generative Language Model

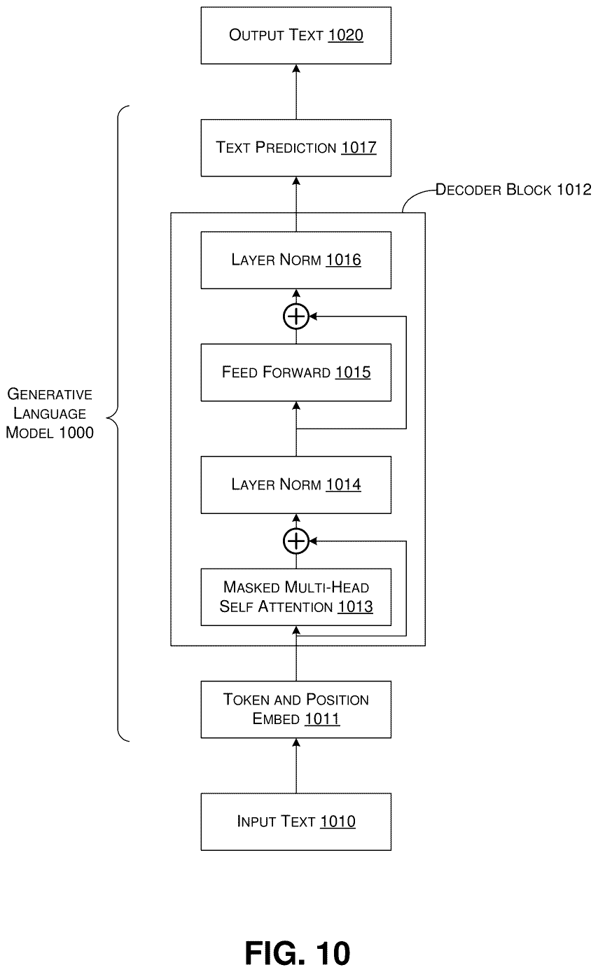

FIG. 10 illustrates an exemplary generative language model 1000 (e.g., a transformer-based decoder) that can be employed using the disclosed implementations. (Radford, et al., “Improving language understanding by generative pre-training,” 2018). Generative language model 1000 is an example of a machine learning model that can be used to perform one or more natural language processing tasks that involve generating text, as discussed more below. For the purposes of this document, the term “natural language” means language that is normally used by human beings for writing or conversation.

Generative language model 1000 can receive input text 1010, e.g., a prompt from a user or a prompt generated automatically by machine learning using the disclosed techniques. For instance, the input text can include words, sentences, phrases, or other representations of language. The input text can be broken into tokens and mapped to token and position embeddings 1011 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 1011 are processed in one or more decoder blocks 1012. Each decoder block implements masked multi-head self-attention 1013, which is a mechanism relating different positions of tokens within the input text to compute the similarities between those tokens. Each token embedding is represented as a weighted sum of other tokens in the input text. Attention is only applied for already-decoded values, and future values are masked. Layer normalization 1014 normalizes features to mean values of 0 and variance to 1, resulting in smooth gradients. Feed forward layer 1015 transforms these features into a representation suitable for the next iteration of decoding, after which another layer normalization 1016 is applied. Multiple instances of decoder blocks can operate sequentially on input text, with each subsequent decoder block operating on the output of a preceding decoder block. After the final decoding block, text prediction layer 1017 can predict the next word in the sequence, which is output as output text 1020 in response to the input text 1010 and also fed back into the language model. The output text can be a newly-generated response to the prompt provided as input text to the generative language model.

Generative language model 1000 can be trained using techniques such as next-token prediction or masked language modeling on a large, diverse corpus of documents. For instance, the text prediction layer 1017 can predict the next token in a given document, and parameters of the decoder block 1012 and/or text prediction layer can be adjusted when the predicted token is incorrect. In some cases, a generative language model can be pretrained on a large corpus of documents. Then, a pretrained generative language model can be tuned using a reinforcement learning technique such as reinforcement learning from human feedback (“RLHF”).

### Device Implementations

As noted above with respect to FIG. 7, system 700 includes several devices, including a client device 710, a client device 720, one or more server(s) 730, one or more server(s) 740, and one or more server(s) 740. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 750. Without limitation, network(s) 750 can include one or more local area networks (LANs), wide area networks (WANs), the Internet, and the like.

### Additional Examples

Various examples are described above. Additional examples are described below. One example includes a computer-implemented method comprising retrieving log entries from a log file, the log entries having been generated by one or more hardware or software resources in a computing system, prompting a generative language model to generate templates that match the log entries, receiving the generated templates from the generative language model, prompting the generative language model to evaluate suitability of the generated templates for generating alert rules, receiving, from the generative language model, indications that selected templates are suitable for generating the alert rules, and generating the alert rules based at least on the selected templates.

Another example can include any of the above and/or below examples where the generated templates comprises regular expressions.

Another example can include any of the above and/or below examples where the method further comprises providing example templates to the generative language model when prompting the generative language model to generate the templates.

Another example can include any of the above and/or below examples where the method further comprises storing the generated templates in a template repository, extracting constants from subsequent log entries and selecting a subset of the generated templates in the template repository that include the extracted constants, determining whether the subsequent log entries match any of the generated templates of the subset, and prompting the generative language model to generate a new template when a particular log entry does not match any of the generated templates in the subset.

Another example can include any of the above and/or below examples where the method further comprises verifying that the generated templates match corresponding log entries prior to storing the generated templates in the template repository.

Another example can include any of the above and/or below examples where the method further comprises in an instance when a particular generated template does not match a particular log entry used to generate the particular generated template, parsing the particular log entry with a rules-based parser to generate a parsing-based template and storing the parsing-based template in the template repository instead of the particular generated template.

Another example can include any of the above and/or below examples where the method further comprises prompting the generative language model to generate variable descriptions of individual variables in the generated templates and providing the generated variable descriptions to the generative language model when prompting the generative language model to evaluate the suitability of the generated templates for generating the alert rules.

Another example can include any of the above and/or below examples where the method further comprises prompting the generative language model multiple times to determine whether a particular generated template is suitable for different alert rule types given the generated variable descriptions.

Another example can include any of the above and/or below examples where the alert rule types include a threshold alert rule type, a log count alert rule type, a ratio alert rule type, a new value alert rule type, a unique count alert rule type, a response time alert rule type, an outlier alert rule type, and an oscillation alert rule type.

Another example can include any of the above and/or below examples where the method further comprises providing the generative language model with alert rule descriptions for each alert rule type.

Another example can include any of the above and/or below examples where the method further comprises prompting the generative language model to generate rule components for the alert rules, receiving the generated rule components from the generative language model, and assembling the generated rule components into a rule format, the assembling resulting in the generated alert rules.

Another example can include any of the above and/or below examples where the method further comprises validating the generated alert rules to obtain validated alert rules.

Another example can include any of the above and/or below examples where the method further comprises deploying the validated alert rules and generating alerts when subsequent log entries match the validated alert rules.

Another example can include any of the above and/or below examples where the method further comprises implementing at least one mitigation action for a particular hardware or software resource based on at least one generated alert.

Another example includes a system comprising a processor and a storage medium storing instructions which, when executed by the processor, cause the system to retrieve log entries from a log file, the log entries having been generated by one or more hardware or software resources in a computing system, prompt a generative language model to generate templates that match the log entries, receive the generated templates from the generative language model, prompt the generative language model to evaluate suitability of the generated templates for generating alert rules, receive, from the generative language model, indications that selected templates are suitable for generating the alert rules, and generate the alert rules based at least on the selected templates

Another example can include any of the above and/or below examples where the instructions, when executed by the processor, cause the system to apply at least one of the alert rules to subsequent log entries and generate alerts for individual subsequent log entries that match individual alert rules.

Another example can include any of the above and/or below examples where the instructions, when executed by the processor, cause the system to generate a graphical user interface representing the generated alerts and output the graphical user interface.

Another example can include any of the above and/or below examples where the instructions, when executed by the processor, cause the system to implement at least one mitigation action for a particular hardware or software resource based on at least one generated alert.

Another example can include any of the above and/or below examples where the instructions, when executed by the processor, cause the system to send a notification to another computing device indicating that a particular alert has been generated.

Another example includes a computer-readable storage medium storing instructions which, when executed by a processing device, cause the processing device to perform acts comprising retrieving log entries from a log file, the log entries having been generated by one or more hardware or software resources in a computing system, prompting a generative language model to generate templates that match the log entries, receiving the generated templates from the generative language model, prompting the generative language model to evaluate suitability of the generated templates for generating alert rules, receiving, from the generative language model, indications that selected templates are suitable for generating the alert rules, and generating the alert rules based at least on the selected templates.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
retrieving log entries from a log file, the log entries having been generated by one or more hardware or software resources in a computing system;
prompting a generative language model to generate templates that match the log entries;
receiving the generated templates from the generative language model;
prompting the generative language model to evaluate suitability of the generated templates for generating alert rules;
receiving, from the generative language model, indications that selected templates are suitable for generating the alert rules; and
generating the alert rules based at least on the selected templates.

2. The computer-implemented method of claim 1, the generated templates comprising regular expressions.

3. The computer-implemented method of claim 2, further comprising:
providing example templates to the generative language model when prompting the generative language model to generate the templates.

4. The computer-implemented method of claim 1, further comprising:
storing the generated templates in a template repository;
extracting constants from subsequent log entries and selecting a subset of the generated templates in the template repository that include the extracted constants;
determining whether the subsequent log entries match any of the generated templates of the subset; and
prompting the generative language model to generate a new template when a particular log entry does not match any of the generated templates in the subset.

5. The computer-implemented method of claim 4, further comprising:
verifying that the generated templates match corresponding log entries prior to storing the generated templates in the template repository.

6. The computer-implemented method of claim 5, further comprising:
in an instance when a particular generated template does not match a particular log entry used to generate the particular generated template:
parsing the particular log entry with a rules-based parser to generate a parsing-based template; and
storing the parsing-based template in the template repository instead of the particular generated template.

7. The computer-implemented method of claim 1, further comprising:
prompting the generative language model to generate variable descriptions of individual variables in the generated templates; and
providing the generated variable descriptions to the generative language model when prompting the generative language model to evaluate the suitability of the generated templates for generating the alert rules.

8. The computer-implemented method of claim 7, further comprising:
prompting the generative language model multiple times to determine whether a particular generated template is suitable for different alert rule types given the generated variable descriptions.

9. The computer-implemented method of claim 8, the alert rule types including a threshold alert rule type, a log count alert rule type, a ratio alert rule type, a new value alert rule type, a unique count alert rule type, a response time alert rule type, an outlier alert rule type, and an oscillation alert rule type.

10. The computer-implemented method of claim 9, further comprising:
providing the generative language model with alert rule descriptions for each alert rule type.

11. The computer-implemented method of claim 1, further comprising:
prompting the generative language model to generate rule components for the alert rules;
receiving the generated rule components from the generative language model; and
assembling the generated rule components into a rule format, the assembling resulting in the generated alert rules.

12. The computer-implemented method of claim 1, further comprising:
validating the generated alert rules to obtain validated alert rules.

13. The computer-implemented method of claim 12, further comprising
deploying the validated alert rules; and
generating alerts when subsequent log entries match the validated alert rules.

14. The computer-implemented method of claim 13, further comprising:
implementing at least one mitigation action for a particular hardware or software resource based on at least one generated alert.

15. A system comprising:
a processor; and
a storage medium storing instructions which, when executed by the processor, cause the system to:
retrieve log entries from a log file, the log entries having been generated by one or more hardware or software resources in a computing system;
prompt a generative language model to generate templates that match the log entries;
receive the generated templates from the generative language model;
prompt the generative language model to evaluate suitability of the generated templates for generating alert rules;
receive, from the generative language model, indications that selected templates are suitable for generating the alert rules; and
generate the alert rules based at least on the selected templates.

16. The system of claim 15, wherein the instructions, when executed by the processor, cause the system to:
apply at least one of the alert rules to subsequent log entries; and
generate alerts for individual subsequent log entries that match individual alert rules.

17. The system of claim 16, wherein the instructions, when executed by the processor, cause the system to:
generate a graphical user interface representing the generated alerts; and
output the graphical user interface.

18. The system of claim 16, wherein the instructions, when executed by the processor, cause the system to:
implement at least one mitigation action for a particular hardware or software resource based on at least one generated alert.

19. The system of claim 16, wherein the instructions, when executed by the processor, cause the system to:
send a notification to another computing device indicating that a particular alert has been generated.

20. A computer-readable storage medium storing instructions which, when executed by a processing device, cause the processing device to perform acts comprising:
retrieving log entries from a log file, the log entries having been generated by one or more hardware or software resources in a computing system;
prompting a generative language model to generate templates that match the log entries;
receiving the generated templates from the generative language model;
prompting the generative language model to evaluate suitability of the generated templates for generating alert rules;
receiving, from the generative language model, indications that selected templates are suitable for generating the alert rules; and
generating the alert rules based at least on the selected templates.
